(19) United States
(12) Patent Application Publication
(10) Pub. No.: US 2006/0047529 A1
(43) Pub. Date: Mar. 2, 2006

(54) Practice management consulting system

(76) Inventor: Sean A. Fahimi, Irvine, CA (US)

Correspondence Address: STETINA BRUNDA GARRED & BRUCKER, 75 ENTERPRISE, SUITE 250, ALISO VIEJO, CA, 92656, US

(21) Appl. No.: 10/930,374

(22) Filed: Aug. 31, 2004

(51) Int. Cl. G06Q 99/00

(52) U.S. Cl. 705/1

(57) ABSTRACT

A practice management consulting system and related methods are provided for facilitating the communication of business consulting information and advice to a user, without the need for hiring a business consultant. A user of the system can interact with a user interface provided by a browser running on a computing device accessible by the user. Educational materials pertaining to business practice management can be accessed by the user by selecting from a set of links displayed in the user interface. A plurality of user-selectable interactive processes can be made available by the system for analyzing the performance of the user's business pertaining to the office, finances, overhead, budget, and/or referrals associated with the business. The user can enter business information to be processed by the system. The system can display the results of the processing, comprising business consulting advice pertaining to the business practice of the user.

### CROSS-REFERENCE TO RELATED APPLICATIONS

Not Applicable

### STATEMENT RE: FEDERALLY SPONSORED RESEARCH/DEVELOPMENT

Not Applicable

### BACKGROUND OF THE INVENTION

In the marketplace, businesspersons face constant pressure to run their business practices as effectively as possible. Such pressures can be especially acute in healthcare-related industries where costs and inefficiencies must be kept in check. Healthcare professionals often face the unenviable task of balancing the obligation to provide quality patient care with the need to make such patient care affordable.

One existing way for businesses to increase their efficiency is through obtaining the services of business consultants who specialize in providing business-specific advice. Typically, such consulting services require a visit from a consultant who observes how the business is run and then provides advice based on such observations.

Unfortunately, such consulting services can be uneconomical and cumbersome for healthcare professionals to utilize. The fees typically charged by such consultants can be significant, often costing upwards of many thousands of dollars, or a non-trivial percentage of the healthcare professional's income. Healthcare professionals must also absorb the costs associated with the time invested in meeting with such consultants. Consequently, the costs incurred when utilizing business consulting services can be a major business expense for healthcare professionals.

In addition, the availability of consultants can vary depending on the consultant's schedule, requiring the healthcare professional to adjust office schedules to accommodate the consultant's availability. Moreover, the quality of advice given by such consultants may be based on a relatively small time period of observation which may not provide a comprehensive examination of the general practice of the office. Furthermore, the presence of an observing party in the office may cause patients discomfort.

In view of these various drawbacks, there exists a need for improved methods and systems for providing business consulting services to businesspersons. In particular, there is a need for an improved business consulting model as applied to healthcare-related industries.

### BRIEF SUMMARY OF THE INVENTION

The present invention, roughly described, relates generally to technology for providing business consulting services, and more particularly to methods and systems for facilitating the management of a business. A practice management consulting system in accordance with the present invention can provide business consulting services to a user, without the need for hiring a business consultant.

In various embodiments, a user of the system can interact with a user interface provided by a browser running on a computing device accessible by the user. A set of links can be provided to the user for accessing educational materials pertaining to business practice management. A variety of different interactive processes may be made available by the system for analyzing the performance of the user's business pertaining to the office, finances, overhead, budget, and/or referrals associated with the business.

In response to the user's selection of an interactive process, the system can display a page to the user through the user interface, requesting business information from the user. The user can enter business information pertaining to a business practice of the user, and can instruct the system to analyze/process the business information in accordance with the selected interactive process. The system can display the results of the processing through the user interface, with the results comprising business consulting advice pertaining to the business practice of the user.

In certain embodiments, the results can include ratings of a plurality of aspects of the business practice of the user. Such results can further include links associated with educational information pertaining to at least one of the aspects of the business practice rated in the results.

These and other embodiments of the present invention are discussed in further detail below.

### BRIEF DESCRIPTION OF THE DRAWINGS

FIG. 1 is a block diagram illustrating a practice management consulting system with application software running on a user's computing device in accordance with an embodiment of the present invention.

FIG. 2 is a block diagram illustrating a practice management consulting system with application software running on a networked server in accordance with an embodiment of the present invention.

FIG. 3 illustrates a welcome screen of a user interface presented to a user of a practice management consulting system in accordance with an embodiment of the present invention.

FIGS. 4A-J illustrate various screens associated with informational materials that can be presented to a user of a practice management consulting system in accordance with an embodiment of the present invention.

FIG. 5 is a flowchart describing a process of user interaction with a practice management consulting system in accordance with an embodiment of the present invention.

FIG. 6 is a flowchart describing a process performed by application software and a browser of a practice management consulting system in accordance with an embodiment of the present invention.

FIGS. 7A-G illustrate various screens associated with tests and tools that can be presented to a user of a practice management consulting system in accordance with an embodiment of the present invention.

### DETAILED DESCRIPTION OF THE INVENTION

A practice management consulting system in accordance with the present invention can provide users with software tools for analyzing their respective business practices. Consulting advice can be provided to users in response to such analysis and, in various embodiments, supplemental educational materials may also be provided by the system to users in addition to the consulting advice. For example, in response to business-related information entered by a user, the system can process the information and provide consulting advice to the user pertaining to the user's business. In various embodiments, the system can be implemented using a plurality of linked web pages, some of which are configured to receive business information input by the user. The pages can be linked using hypertext links and/or any appropriate linking technology known in the art.

Although the practice management system and related methods of the present invention are chiefly described herein with regard to the management of a dental practice, it will be appreciated that the present invention can also be applied to the management of businesses in the field of healthcare (such as medicine) and/or other businesses outside the field of healthcare.

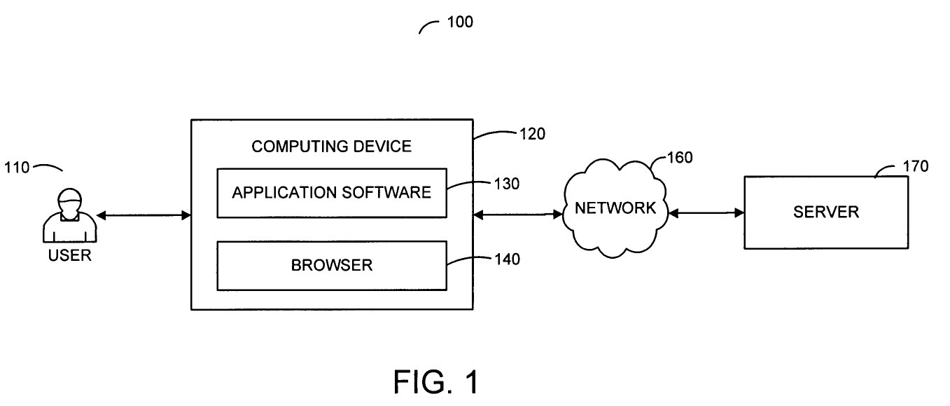

FIG. 1 is a block diagram illustrating an embodiment 100 of a practice management consulting system with application software 130 running on a user's 110 computing device 120. As illustrated in FIG. 1, a user 110 (such as a businessperson or a person associated with the businessperson) of the system can have an associated computing device 120. Computing device 120 can be any computing device known in the art capable of running software for providing various functionality to be provided by the system as further described herein. In various embodiments, computing device 120 can be a conventional personal computer, laptop computer, workstation, terminal, and/or any other type of computing device known in the art.

Application software 130 running on computing device 120 can be provided for instructing the computing device 120 to perform specific functionality of the system described more fully herein. A database (not shown) can also be provided, on computing device 120 or otherwise, for storing information pertaining to the business practice of the user. A browser 140 running on computing device 120 can be used by the system to provide a convenient and familiar user interface (such as a web-based graphical user interface) to the user for interacting with application software 130.

The embodiment 100 of FIG. 1 can also be implemented to permit computing device 120 to communicate with a server 170 over a network 160. Server 170 can be implemented as any appropriate server, such as a web server, capable of supporting an online subscription service accessible from the computing device 120, as further described herein. It will be appreciated that network 160 can be any of the various networks known in the art to facilitate data transmission, including but not limited to the Internet, a wide area network (WAN), a virtual private network (VPN), a wireless network, and/or others known in the art.

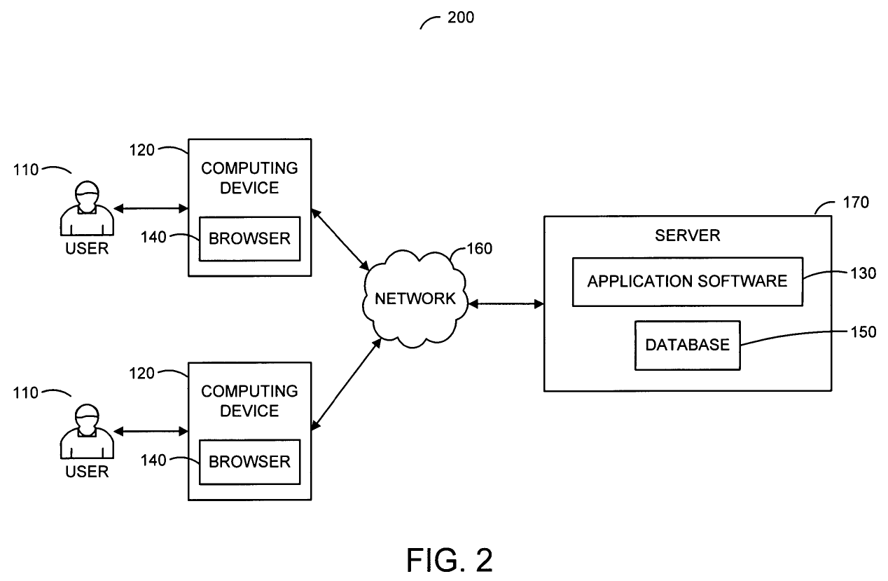

FIG. 2 is a block diagram illustrating an alternate embodiment 200 of a practice management consulting system with application software 130 running on a networked server 170. As illustrated in FIG. 2, a plurality of users 110 can each have an associated computing device 120 in communication with server 170 over network 160. In contrast to the embodiment illustrated in FIG. 1, the application software 130 of FIG. 2 runs on server 170 for instructing the server 170 to perform specific functionality provided by the application software 130, as more fully described herein. As a result, a plurality of users can access the features of the system through a plurality of computing devices 120 in communication with a web site provided by server 170. A database 150 is also provided on server 170 for storing information pertaining to the business practices of each of the respective users of the system. It will also be appreciated that although database 150 is illustrated as running on server 170, the storage of information pertaining to business practices can be provided in accordance with any storage technology known in the art, including but not limited to one or more separate databases. A browser 140 also running on each of the computing devices 120 of FIG. 2 can provide a user interface to users for interacting with application software 130 over network 160.

Although the system of the present invention can be implemented in accordance with embodiment 100 of FIG. 1, embodiment 200 of FIG. 2, as well as other embodiments in accordance with the present disclosure, the functionality of the system more fully described herein can be applied to any of such embodiments, where appropriate.

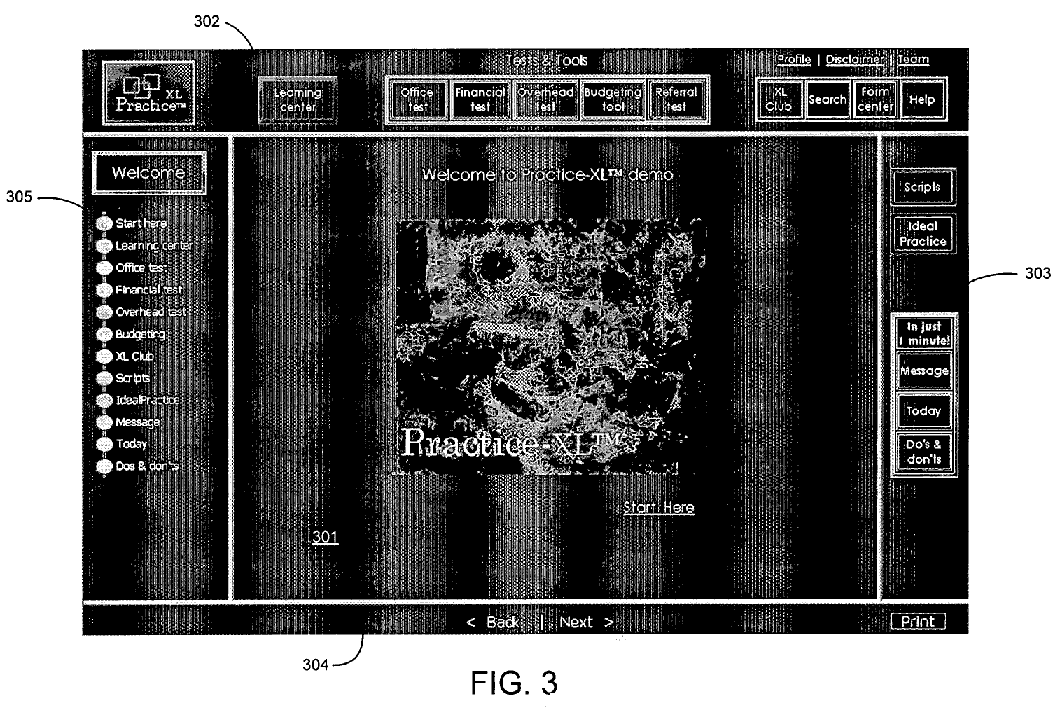

FIG. 3 illustrates a screen shot of a user interface presented to a user of a practice management consulting system in accordance with an embodiment of the present invention. In various embodiments, the screen shot of FIG. 3 can be displayed by a browser 140 running on a computing device 120 when a user of the system first starts and/or accesses the application software 130 of the system.

As illustrated in FIG. 3, the user interface comprises five primary window panes: 301, 302, 303, 304, and 305, with various information and/or links displayed in each of the panes. A user can select various linked pages by “clicking” on the links using a mouse controller or by utilizing any suitable input device of the user's computing device 120. Upon the user's selection of a link, the user interface can be updated by the system to display the linked page.

The center pane 301 can provide various information to the user during the course of the user's interaction with the system. Such information can include, but need not be limited to: educational information, the results of processing performed by the system, recommendations concerning the user's business practice, business consulting advice, and/or other information.

The left-side pane 305 provides a list of links that a user may select to access particular pages associated with the various links displayed in panes 302 and/or 303. As reflected in various screen shots further described herein, the list of links displayed in the left-side pane of the user interface can be updated in response to a user's selection of various links displayed in panes 302 and/or 303. As a result, the left-side pane of the user interface can provide context-sensitive links to pages with information relevant to the particular functionality that the user has selected.

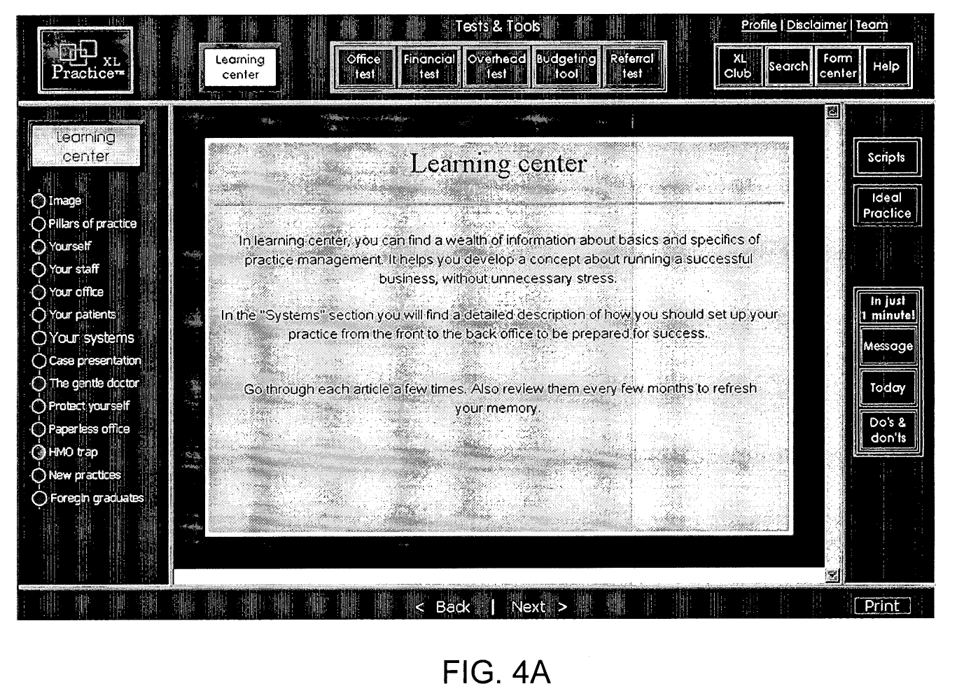

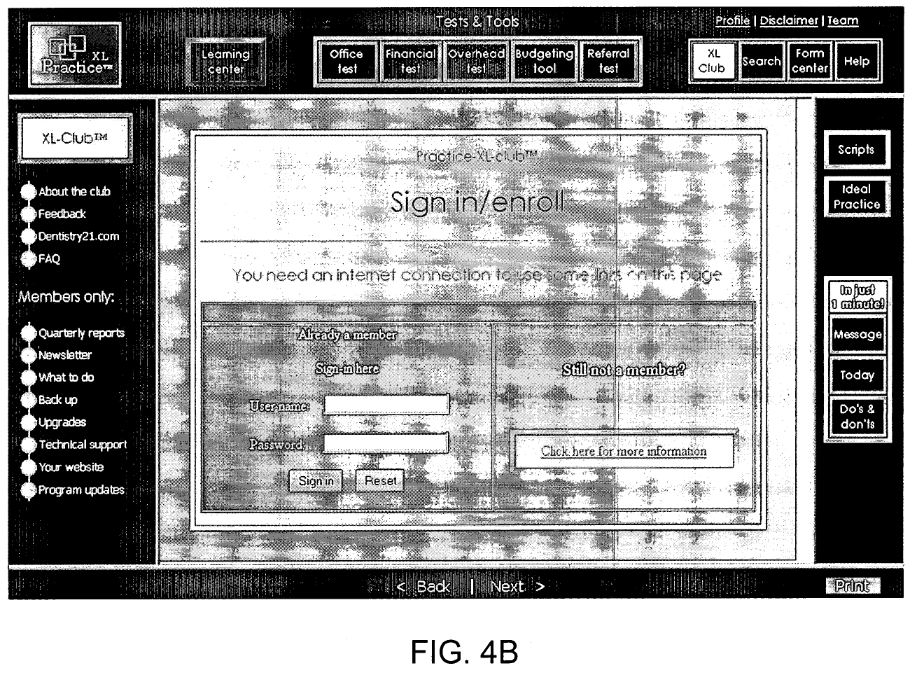

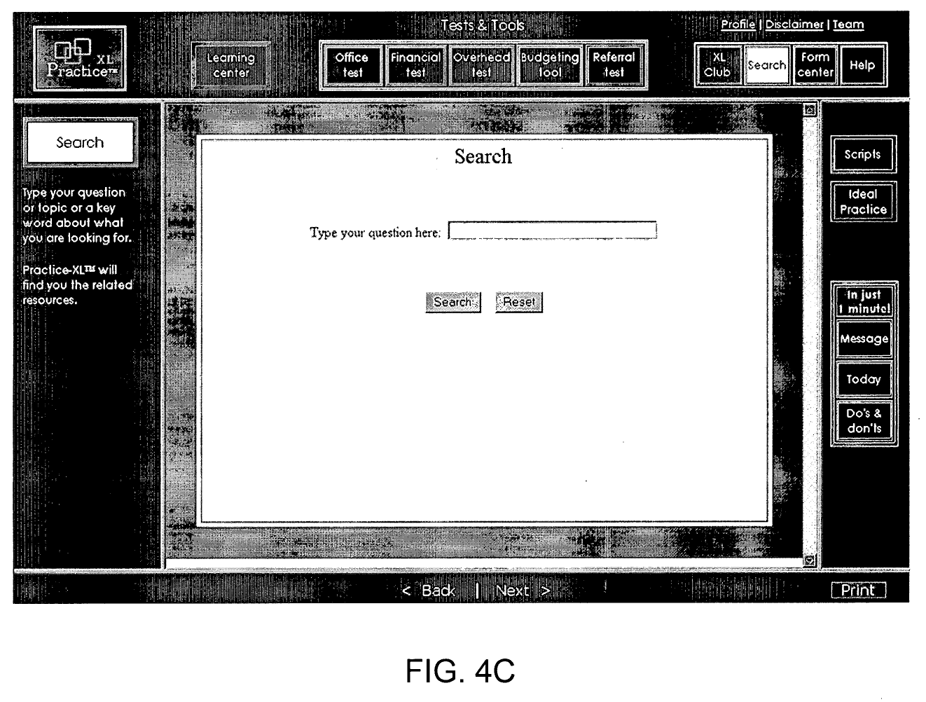

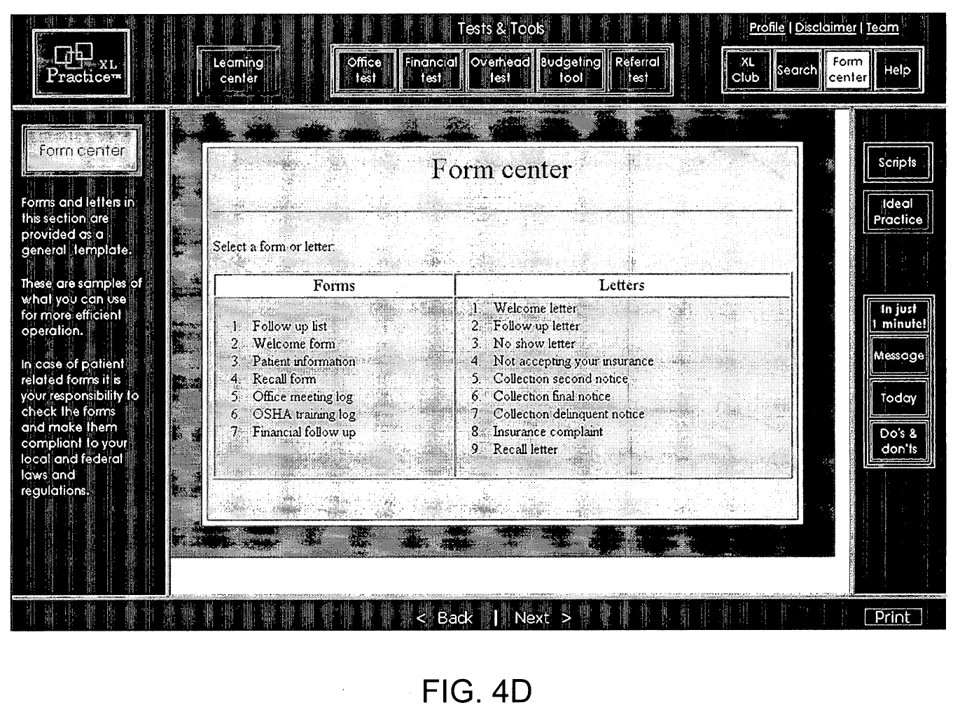

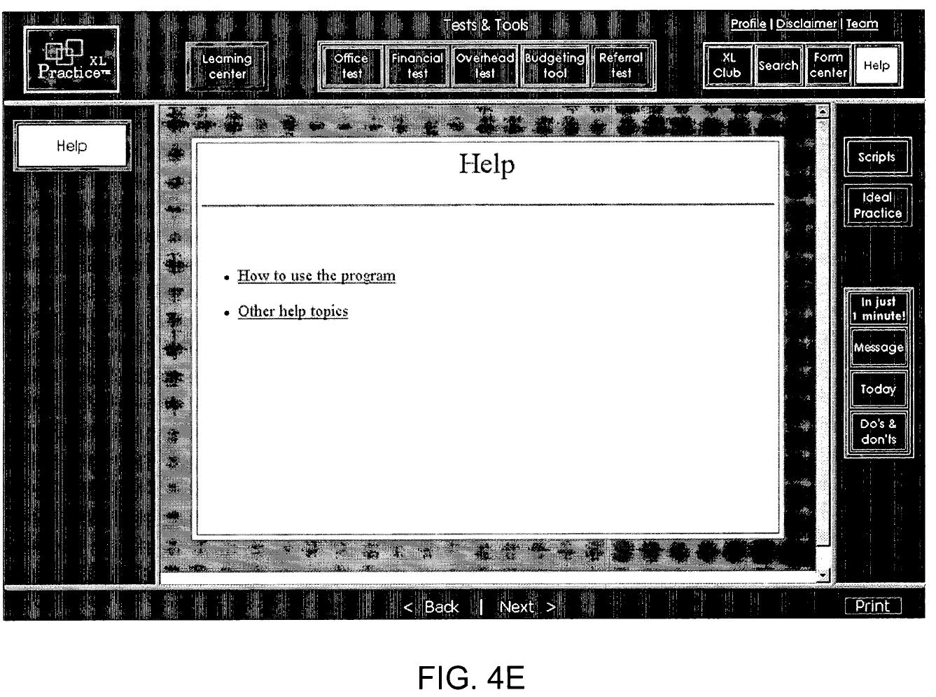

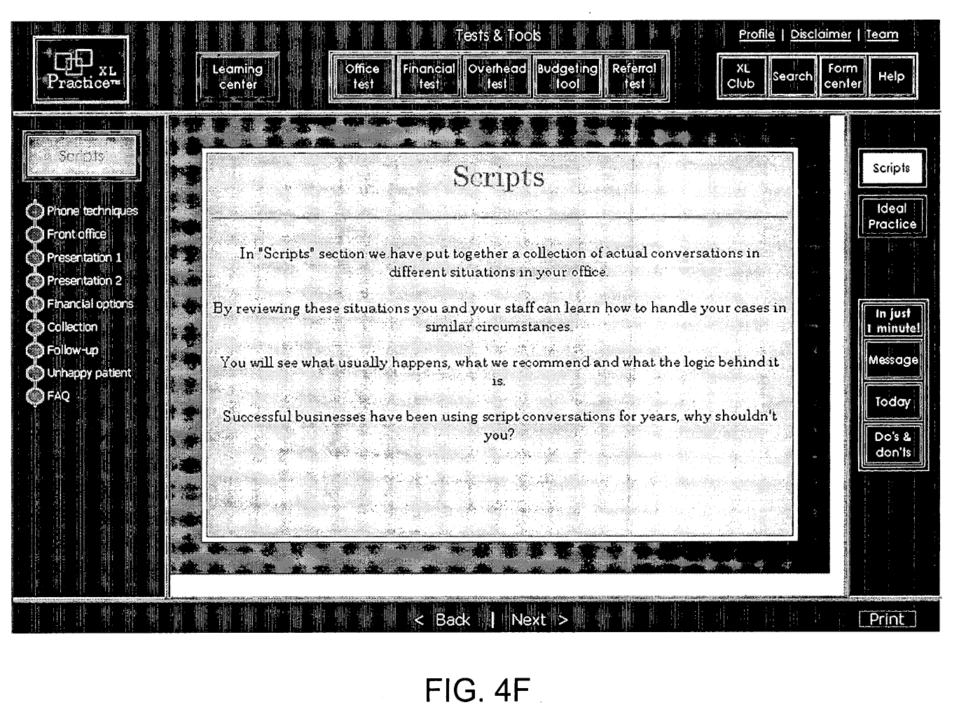

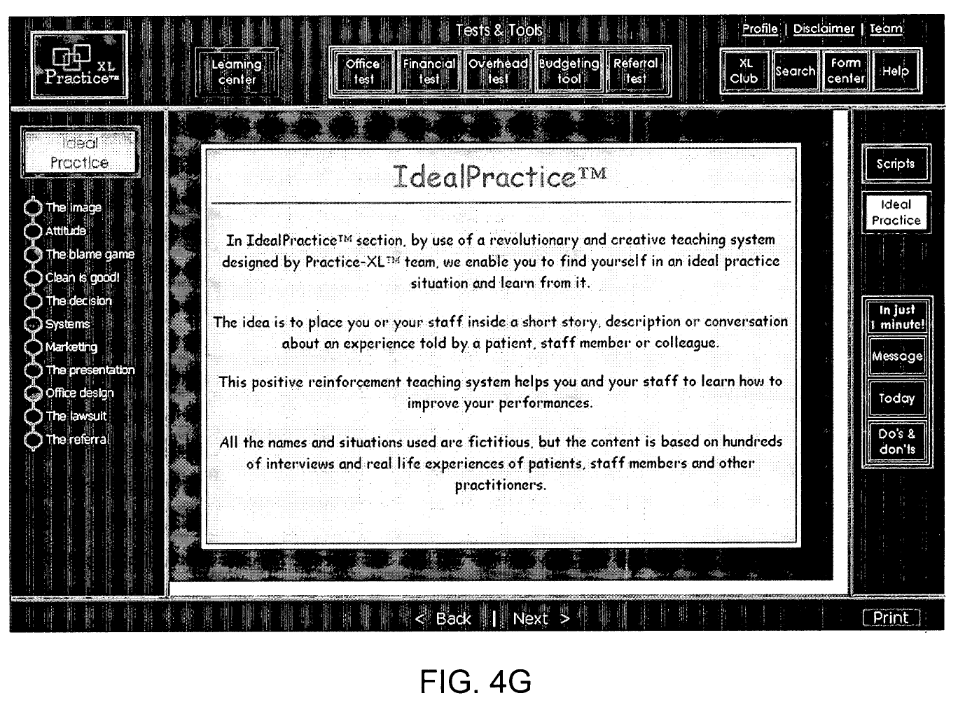

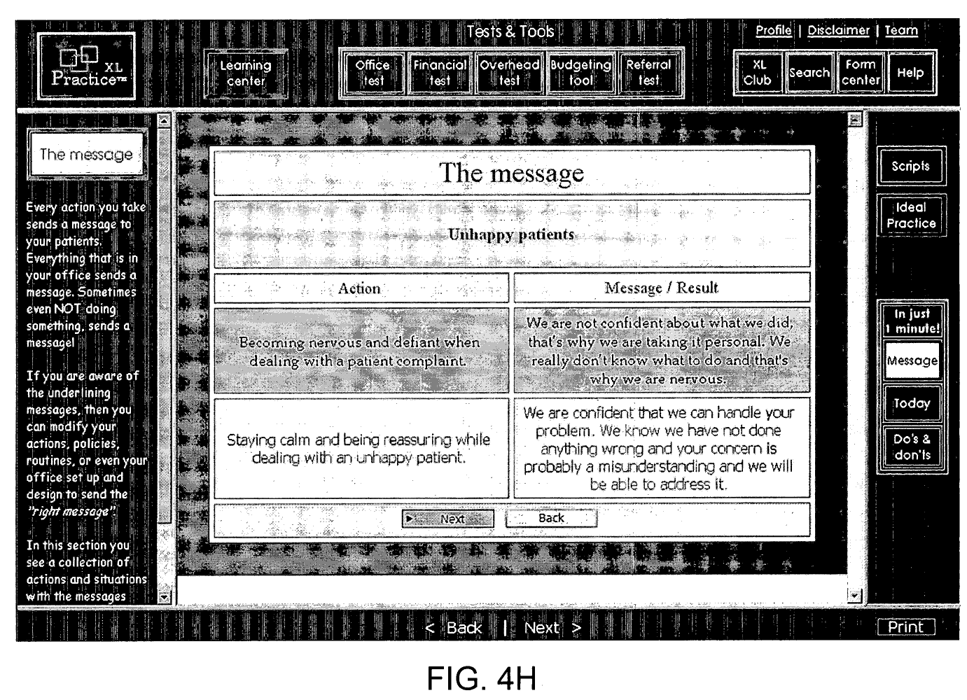

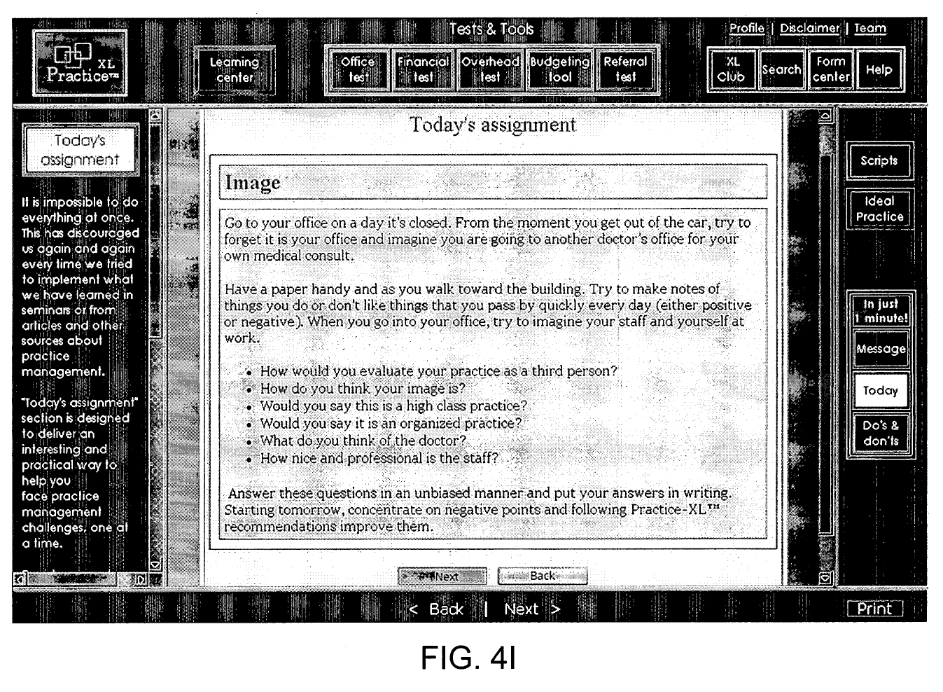

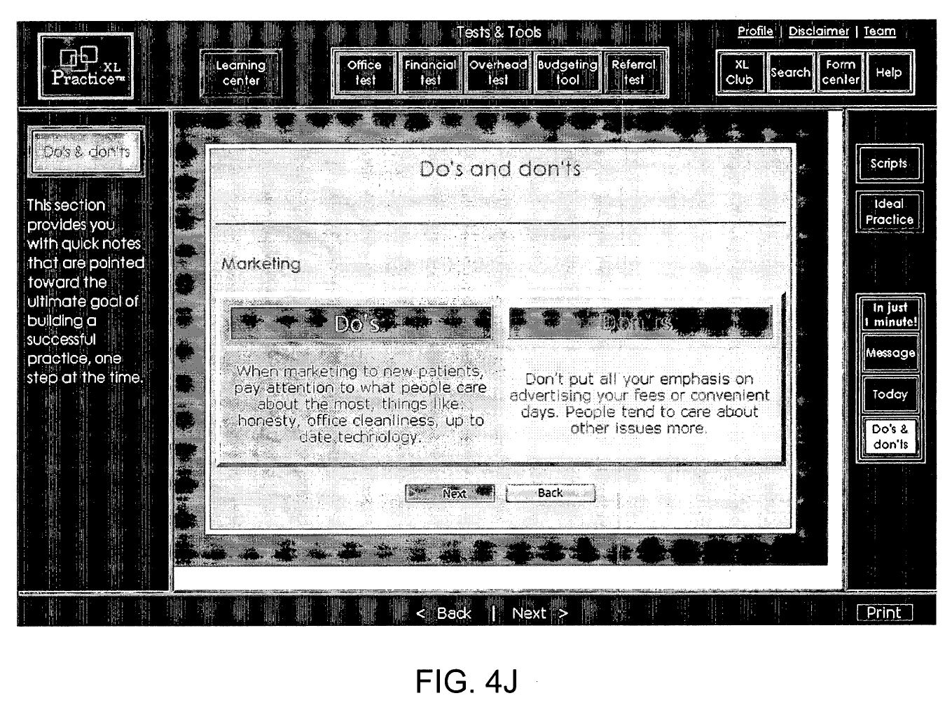

The top pane 302 provides a plurality of user-selectable links that allow a user to access various features of the system. Specifically, the left-most “XL Practice™” link allows the user to access the welcome screen displayed in FIG. 3. The “Learning center” link allows the user to access various educational information concerning business practice management. For example, by selecting the “Learning center” link, a user can access such educational materials electronically. FIG. 4A illustrates a sample screen shot of a learning center page that can be presented to a user in response to the user's selection of the “Learning center” link. Particular pages containing educational materials pertaining to specific subjects can be accessed by the user by selecting pages from the list of links displayed in the left-side pane of FIG. 4A. Upon the user's selection of one of the links, the selected educational material can be displayed to the user in the center window pane of FIG. 4A. In various embodiments, the educational materials can provide basic information concerning practice management, as well as specific consulting advice oriented toward the user's particular business, such as dentistry. It will be appreciated that by providing such functionality, the system allows a user to receive consulting advice in a convenient, accessible format that is relevant to the user's business practice.

Referring again to the top pane 302 of FIG. 3, the five links appearing under “Tests & Tools” provide links to various interactive processes which a user may select in order to access the particular business information processing functionality provided by the system. As illustrated in FIG. 3, the system can be implemented to provide an office test, financial test, overhead test, budgeting tool, and referral test, as further described herein.

The “XL Club” link permits a user to access an online subscription service for providing the user with additional consulting advice. FIG. 4B illustrates a sample screen shot of a login page that can be presented to a user in response to the user's selection of the “XL Club” link. As set forth in FIG. 4B, a user can provide login information in the center pane of the screen, and various information and options can be accessed by the user by selecting pages from the list of links displayed in the left-side pane of FIG. 4B. For example, by paying a membership subscription fee, the user may be permitted to receive quarterly reports concerning the user's business practice, access online message boards, and/or additional features identified in the left-side pane of FIG. 4B. It will be appreciated that in the embodiment 100 of FIG. 1 and the embodiment 200 of FIG. 2, users may access the online subscription service through the communication provided between the user's computing device 120 and server 170.

The “Search” link appearing in the top pane 302 of FIG. 3 permits a user to access a search page for searching the various business practice-related informational materials accessible from the system. FIG. 4C illustrates a sample screen shot of a search page that can be presented to a user in response to the user's selection of the “Search” link.

The “Form Center” link appearing in the top pane 302 of FIG. 3 permits a user to access various examples of sample forms and letters to be used in the user's business practice. FIG. 4D illustrates a sample screen shot of a forms page that can be presented to a user in response to the user's selection of the “Form center” link. Particular pages containing sample forms and letters can be accessed by the user by selecting pages from the list of links displayed in the center pane of FIG. 4D.

The “Help” link appearing in the top pane 302 of FIG. 3 permits a user to access help screens that provide further information concerning the use of the system. FIG. 4E illustrates a sample screen shot of a help page that can be presented to a user in response to the user's selection of the “Help” link. Particular pages containing various help topics associated with the system can be accessed by the user by selecting pages from the list of links displayed in the center pane of FIG. 4E.

The “Profile” link appearing in the top pane 302 of FIG. 3 allows a user to access a set up page where the user can enter information to be stored and used by the system concerning the office profile of the user's business. Such information can include, but need not be limited to: the names of doctors, associates, hygienists, and/or other persons associated with the business. Additional links are provided in the top pane 302 for legal disclaimer information (“Disclaimer”) and information concerning the authors of the various business practice information provided by the system (“Team”).

Turning now to the right-side pane 303 of FIG. 3, additional user-selectable links are provided. The “Scripts” link permits a user to access screens that provide examples of conversations that concern different situations that may occur during the course of the user's business. Supplemental information concerning the logic behind the conversations can also be provided with the conversations. By reviewing the scripts and supplemental information, users can learn how to handle similar circumstances in the course of business. FIG. 4F illustrates a sample screen shot of a scripts page that can be presented to a user in response to the user's selection of the “Scripts” link. Sample scripts pertaining to specific subjects can be accessed by the user by selecting pages from the list of links displayed in the left-side pane of FIG. 4F.

The “Ideal Practice” link appearing in the right-side pane 303 of FIG. 3 permits a user to access short stories, descriptions, and/or conversations about experiences relating to the user's business, as told by a patient, staff member, or colleague. The names of the user and/or other persons associated with the business (obtained from the office profile information stored by the system) can be inserted into the stories to provide positive reinforcement concerning the business practice information set forth in the stories. FIG. 4G illustrates a sample screen shot of an ideal practice page that can be presented to a user in response to the user's selection of the “Ideal Practice” link. Various short stories, descriptions, or conversations can be accessed by the user by selecting pages from the list of links displayed in the left-side pane of FIG. 4G.

An additional three links are provided in the right-side pane 303 of FIG. 3 under the heading “In just 1 minute!” By clicking on the “Message” link, a user can view descriptions of various actions that may be performed in the course of business, and descriptions of the positive and/or negative messages that such actions communicate to clients/patients of the business. The “Today” link permits a user to access descriptions of a series of assignments that can be performed by the user to improve the user's practice management skills. The “Do's & don'ts” link permits a user to access a series of statements describing favored and disfavored business practices. FIGS. 4H, 4I, and 4J illustrate sample screen shots of pages that can be presented to a user in response to the user's selection of the “Message,” “Today,” and “Do's & don'ts” links, respectively.

Turning now to the bottom pane 304 of FIG. 3, additional links (“Back” and “Next”) are provided for permitting a user to navigate between various pages presented in the user interface. A “Print” link is also provided in the bottom pane 304 for printing the page currently displayed in the user interface.

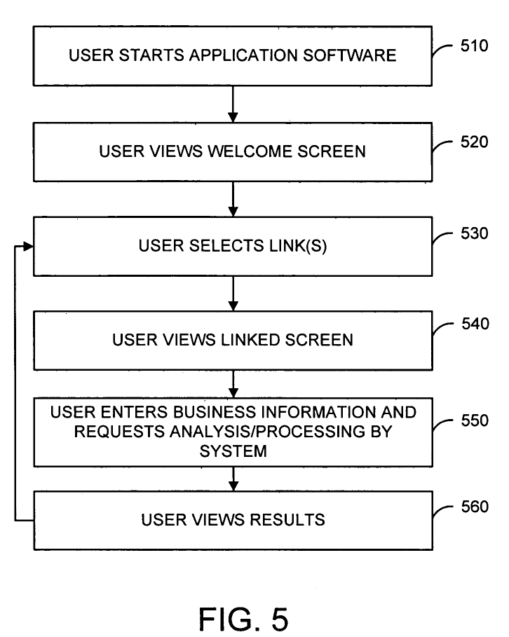

As previously described herein, various embodiments of the business consulting system contemplated by the present invention can provide a plurality of tests and tools for analyzing and processing business information pertaining to a user's business. FIG. 5 is a flowchart describing a process of user interaction with a practice management consulting system in accordance with an embodiment of the present invention. It will be appreciated that the steps of FIG. 5 provide an overview of the general steps performed by a user for entering business information and receiving business consulting advice when interacting with the system through a browser 140 to access the tests and/or tools provided by the system.

At step 510, the user starts the application software 130 of the system. It will be appreciated that step 510 can be performed in various ways, depending on the particular implementation of the system. For example, in embodiment 100 of the system illustrated in FIG. 1, step 510 can be performed by the user choosing to run the application software 130 on the computing device 120. Alternatively, in embodiment 200 of the system illustrated in FIG. 2, step 510 can be performed by a user logging in to a web site maintained by server 170.

Once the application software 130 has been started (step 510), the user can view a welcome screen presented to the user in the browser 140 of the user's computing device 120 (step 520). FIG. 3 previously described herein illustrates a sample welcome screen that can be presented to the user in step 520.

At step 530, the user selects a link, such as a hypertext link, provided on the screen currently viewed by the user in the browser 140. For example, the user may select a link to educational materials or one of the tests or tools displayed in FIG. 3. At step 540, the user is presented with the screen associated with the selected link for viewing in the browser 140. Steps 530 and 540 can be repeated as desired by the user in order to access any of the user-accessible screens provided by the system.

Upon viewing the linked screen, the user may enter information pertaining to the user's business and request that the information be processed by the system (step 550). At step 560, the user is presented with a results screen in which the user can view the results of the processing performed by the system. Such results can include business consulting advice rendered by the system in response to the processing of the business information entered by the user. Thereafter, the process of FIG. 5 returns to step 530 where the user can select another link.

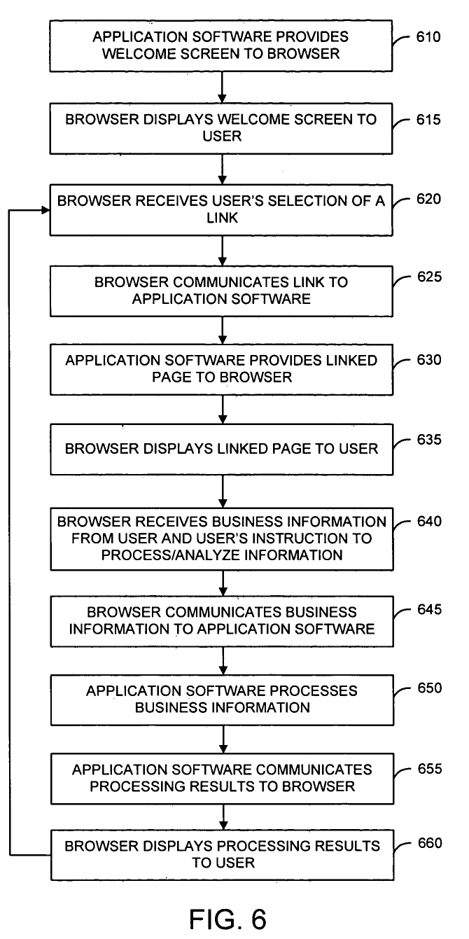

FIG. 6 is a flowchart describing a process performed by application software 130 and a browser 140 of a practice management consulting system in accordance with an embodiment of the present invention. It will be appreciated that the steps of FIG. 6 provide an overview of the general steps performed by the application software 130 and browser 140 of the system in response to the user interaction described above with respect to FIG. 5.

At step 610, the application software 130 provides a welcome screen to the browser 140. This step can be performed in response to the user's starting of the application software 130 as set forth in step 510 of FIG. 5. Upon receiving the welcome screen from the application software 130, the browser 140 displays the welcome screen to the user on the user's computing device 120 (step 615).

The browser 140 then receives the user's selection of a link (step 620) and communicates the link to application software 130 (step 625). It will be appreciated that steps 615 and 620 can be performed by the browser 140 in response to the user's selection of a link in step 530 of FIG. 5.

At step 630, the application software 130 provides the linked page (associated with the link selected by the user) to browser 140. The browser 140 then displays the linked page to the user in step 635.

At step 640, the browser 140 receives business information from the user, as well as the user's instruction to process the information. For example, the business information and instruction may be received in response to the user's actions in step 550 of FIG. 5. The browser 140 then communicates the business information to the application software 130 (step 645) which processes the information (step 650) in accordance with the appropriate test or tool that was selected by the user as a link in step 530 of FIG. 5.

After processing the business information, the application software 130 communicates the processing results to browser 140 (step 655) which then displays the results to the user (step 660). Thereafter, the process of FIG. 6 returns to step 620 where the browser 140 can receive another user selection of a link.

As previously described in relation to the embodiment shown in the screen shot of FIG. 3, a system in accordance with the present invention can be implemented to provide an office test, financial test, overhead test, budgeting tool, and referral test. Results of the various tests and tools can be saved by the system (for example, in database 150) for future use, viewing, and/or retrieval by the user.

Office Test: The office test can be accessed by selecting the “Office test” link from window pane 302 of FIG. 3. It will be appreciated that the selection of the “Office test” link can be performed in step 530 of FIG. 5.

The office test provides a way for a user of the system to receive consulting advice concerning the performance of the user's business, in response to the system's analysis of survey scores entered by the user. The user can administer surveys to patients and then enter the information obtained from the surveys into the system. The questions used in the surveys and the analysis performed by the office test can be implemented to analyze the customer service and patient relations aspects of the business.

In one embodiment, the patient surveys (“office test surveys”) utilized by the office test can be configured to ask patients to provide ratings of the business in response to the following questions:
The courtesy and professionalism of our front office staff on the phone.
Our front office staff attitude when you came to our office.
How organized was our office?
Timing of your visit.
Office cleanliness and appearance.
Professionalism and courtesy of our dental assistants.
Financial arrangement and options available were adequate.
Treatment options and diagnosis were clearly explained to you, all questions were answered.
Your overall satisfaction of your dental treatment provided by your doctor.
Your general impression of our office.
Would you recommend us to others for dental care?

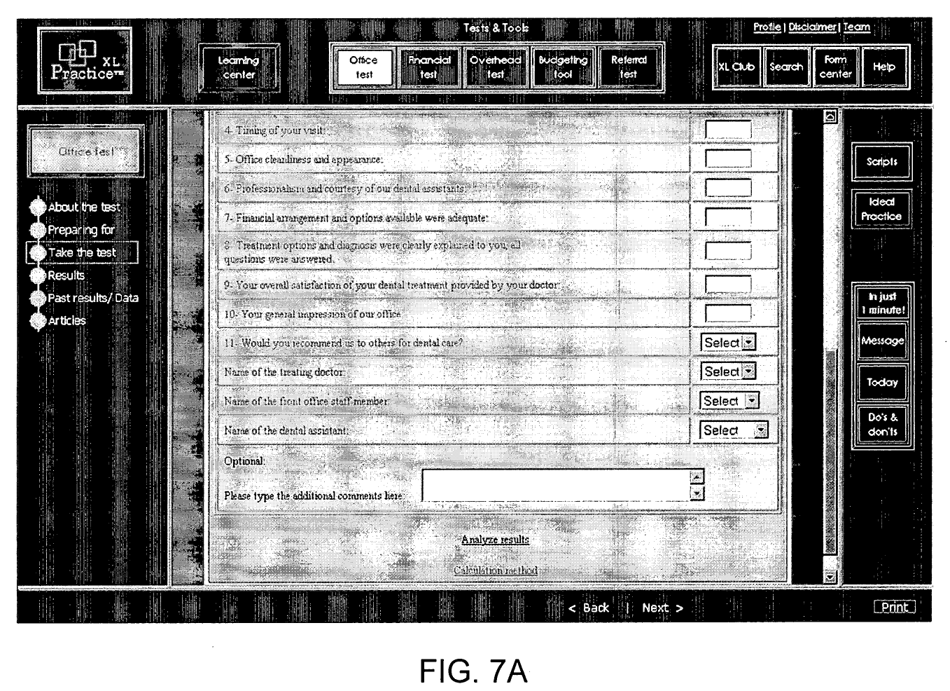

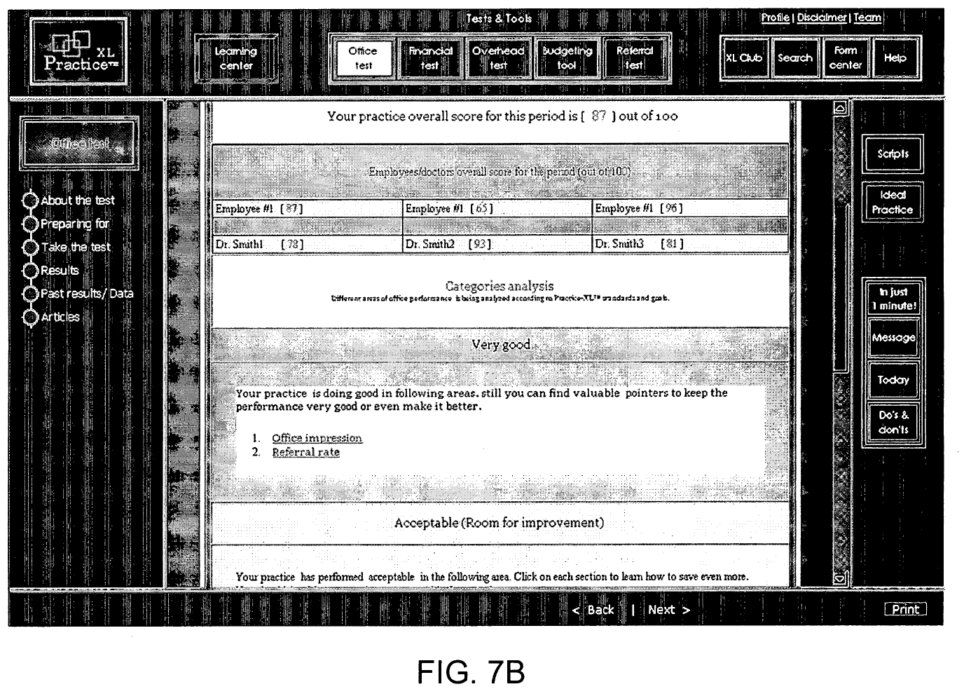

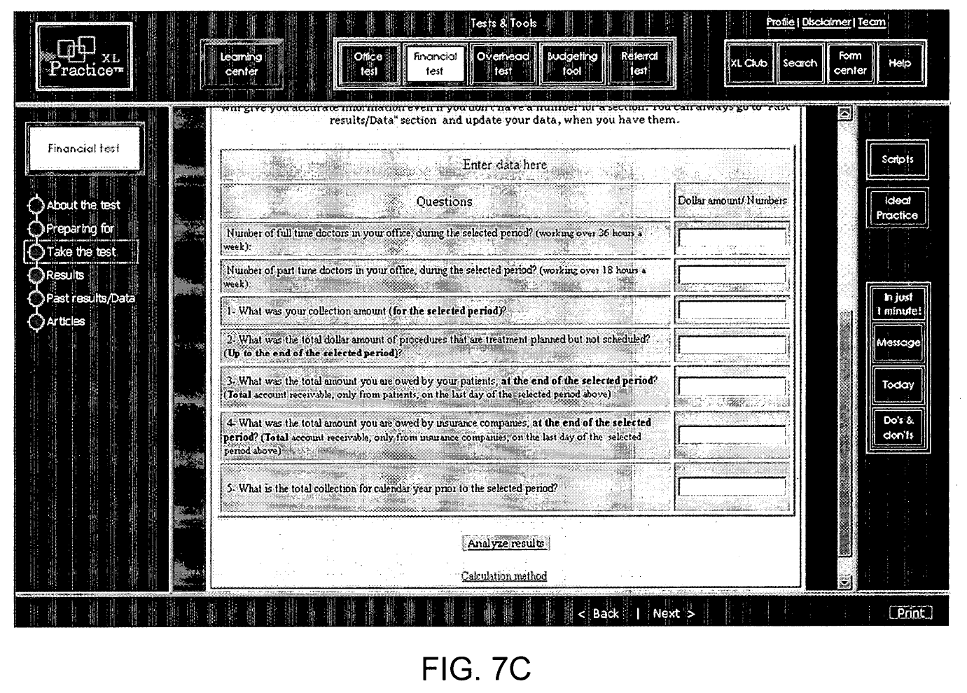

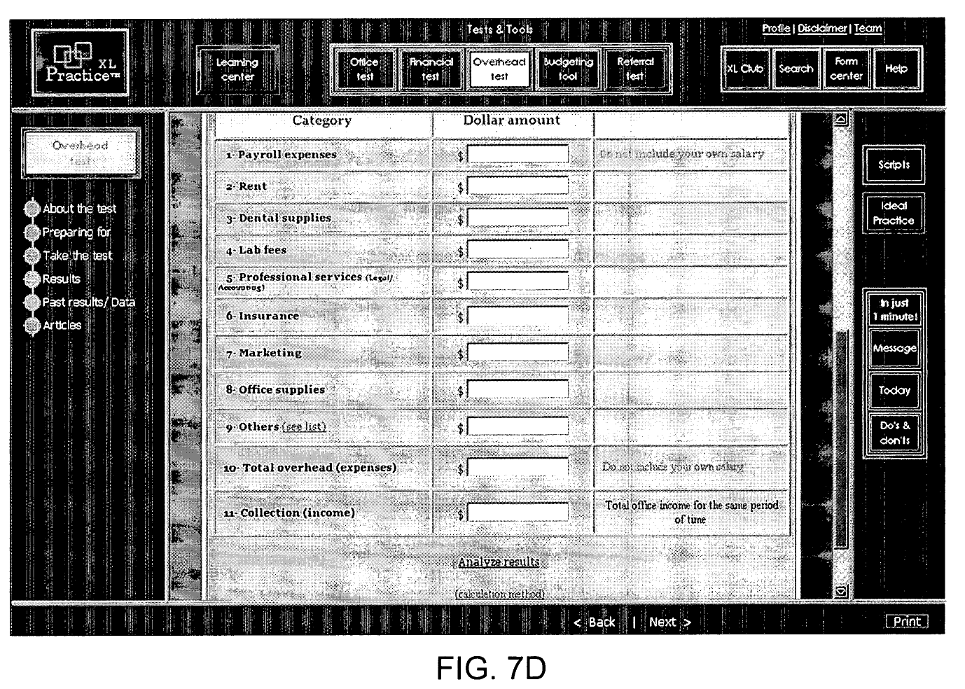

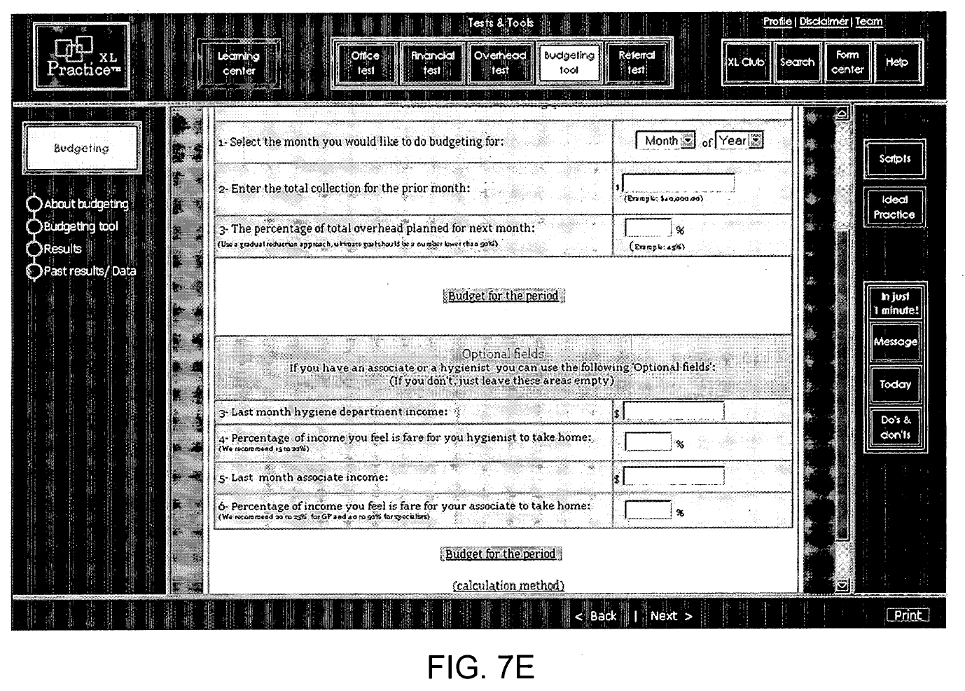

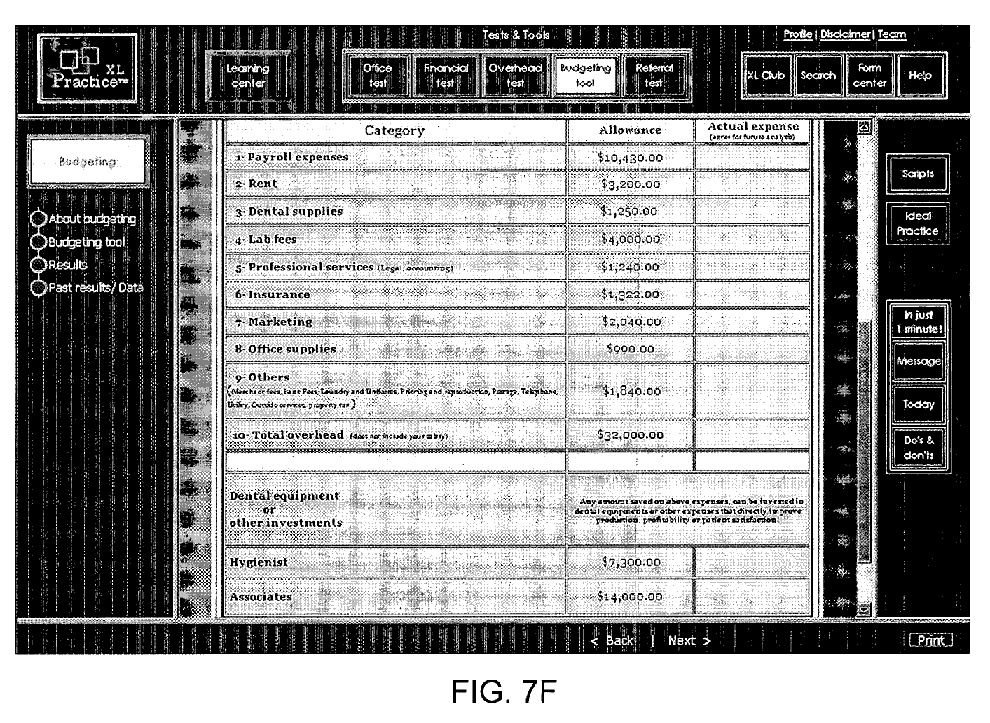

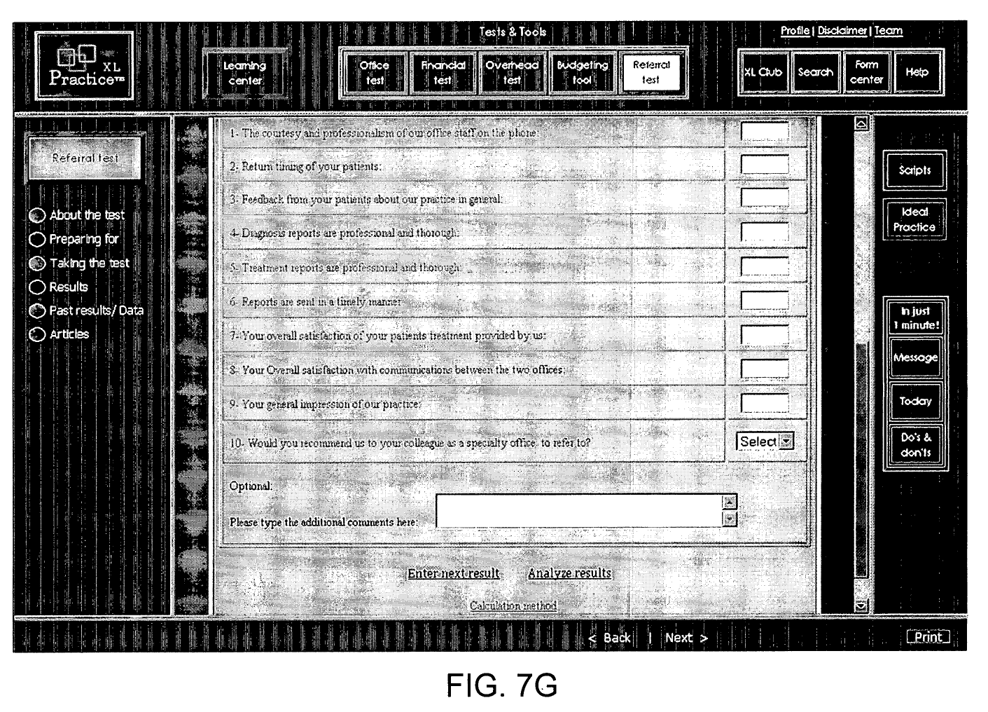

FIG. 7A provides a sample screen shot of one of the pages that can be provided to a user for the office test. Particular pages pertaining to various aspects of the office test can be accessed by the user by selecting pages from the list of links displayed in the left-side pane of FIG. 7A. As illustrated in FIG. 7A, links are provided to pages that permit users to: review general information concerning the office test (“About the test”); learn how to prepare for the office test (“Preparing for”); enter the information obtained in the office test surveys into the system (“Take the test”); view the results of the system's analysis of the office test survey information (“Results”); view past results prepared by the system and the information entered from previous office test surveys (“Past results/Data”); and link to educational materials that provide advice concerning the particular skills evaluated by the office test (“Articles”).

It will be appreciated that in the screen shot of FIG. 7A, the “Take the test” link has been selected. It will also be appreciated that the selection of the link can also be performed in step 530 of FIG. 5.

The information obtained from patients in response to the office test survey questions can be entered into the various fields illustrated in FIG. 7A, with additional fields being accessible by scrolling up or down the screen. The range of time to which the survey applies (such as a range of months) can also be entered into other fields of the screen (not shown).

As further illustrated in FIG. 7A, the name(s) of the treating doctor, front office staff member, and dental assistant to whom the office test survey pertains can also be entered. An optional comments field is also provided for entering any additional comments obtained from the office test surveys. Information obtained from additional office test surveys can be entered by selecting an “Enter next result” link (not shown) provided in the user interface.

After the information obtained from all office test surveys has been entered, the user can choose to click on the “Analyze results” link illustrated in FIG. 7A. It will be appreciated that the entry of office test survey information and the selection of the “Analyze results” link can be performed in step 550 of FIG. 5.

FIG. 7B provides a sample screen shot of a results page that can be displayed to the user in response to the user's selection of the “Analyze results” link for the office test. As illustrated in FIG. 7B, the system can provide an overall score for the user's business practice, as well as individual scores for each employee and doctor associated with the practice. The results page can also provide the results of the analysis performed by the system for different aspects of office performance. In one embodiment, the following aspects of office performance are evaluated by the office test: office impression, referral rate, phone techniques, front office attitude, office organization, patient waiting time, office cleanliness, case presentation, financial options, communication, and doctor's image. Each aspect of office performance can be grouped into different ratings on the results page according to the quality of the office performance determined by the system. In one embodiment, the following ratings can be used: “Very good,” “Acceptable (Room for improvement),” “Need improvement,” and “Need significant improvement.”

It will be appreciated that by reviewing the results page, the user can conveniently determine which aspects of the office are performing well, and which are not. Each aspect of the business practice listed in the results page can be implemented as a link to educational materials pertaining to the particular business practice. As a result of this functionality, the user can conveniently access educational materials to address the particular deficiencies in the user's business practice pertaining to office performance.

In one embodiment, the office test survey information entered by the user can be processed by the system in accordance with the following Table 1, taking the average of all entries in each box:

TABLE 1

| | | Acceptable | | |
|---|---|---|---|---|
| | | (Room for | Need | Need significant |
| Categories | Very good | improvement) | improvement | improvement |
| 1-The courtesy and | 10 | 9-10 | 8-9 | lower or |
| professionalism | | | | equal to 7 |
| of our front office | | | | |
| staff on the phone | | | | |
| 1-Phone techniques | | | | |
| 2-Our front office staff attitude | 10 | 9-10 | 8-9 | lower or |
| when they greeted you first time | | | | equal to 7 |
| you came to our office: | | | | |
| 2-Front office attitude | | | | |
| 3-how organized was our | 10 | 9-10 | 8-9 | lower or |
| office? | | | | equal to 7 |
| 3-Organized office | | | | |
| 4-Timing of your visit: | 10 | 9-10 | 8-9 | lower or |
| 4-Patient waiting time | | | | equal to 7 |
| 5-Office cleanliness and | 10 | 9-10 | 8-9 | lower or |
| appearance: | | | | equal to 7 |
| 5-Office cleanliness | | | | |
| 6-Professionalism and courtesy | 10 | 9-10 | 8-9 | lower or |
| of our dental assistants: | | | | equal to 7 |
| 6-Case presentation | | | | |
| 7-Financial arrangement and | 10 | 9-10 | 8-9 | lower or |
| options available were | | | | equal to 7 |
| adequate: | | | | |
| 7-Financial options | | | | |
| 8-Treatment options and | 10 | 9-10 | 8-9 | lower or |
| diagnosis were clearly | | | | equal to 7 |
| explained to you, your | | | | |
| questions were answered. | | | | |
| 8-Communication | | | | |
| 9-Your overall satisfaction | 10 | 9-10 | 8-9 | lower or |
| of your dental treatment: | | | | equal to 7 |
| 9-Doctor's image | | | | |
| 10-Your general impression | 10 | 9-10 | 8-9 | lower or |
| of our office: | | | | equal to 7 |
| 10-Office impression | | | | |
| Overall score | 100 | 95-100 | 90-95 | under 90 |
| 11-Would you recommend us to | Number of “yes” | 90-97% | 80-89% | lower than 80 |
| others for dental care? | divided by total | | | |
| 11-Referral rate | 98-100% | | | |

| | |
|---|---|
| Name of the front office | Calculate the overall average for the employee (ignore Q11) |
| staff member | |
| Name of the dental assistant | Calculate the overall average for the employee (ignore Q11) |

Enter additional comments for the period in order by numbers

Financial Test: The financial test can be accessed by selecting the “Financial test” link from window pane 502 of FIG. 5. It will be appreciated that the selection of the “Financial test” link can also be performed in step 530 of FIG. 5.

The financial test provides a way for a user of the system to receive consulting advice concerning the financial health of the user's business practice based on the processing of financial information entered by the user in response to questions' presented by the system. In various embodiments, the user can provide responses to the questions based on a selected time period, such as a month, several months, or a calendar year.

In one embodiment, the system can be configured to ask the user to provide financial information in response to the following questions:
Number of full time doctors in your office, during the selected period? (working over 36 hours a week)
Number of part time doctors in your office, during the selected period? (working over 18 hours a week)
What was your collection amount (for the selected period)?
What was the total dollar amount of procedures that are treatment planned but not scheduled? (Up to the end of the selected period)
What was the total amount you are owed by your patients, at the end of the selected period? (Total account receivable, only from patients, on the last day of the selected period)
What was the total amount you are owed by insurance companies, at the end of the selected period? (Total account receivable, only from insurance companies, on the last day of the selected period)
What is the total collection for calendar year prior to the selected period?

FIG. 7C provides a sample screen shot of one of the pages that can be provided to a user for the financial test. Particular pages pertaining to various aspects of the financial test can be accessed by the user by selecting pages from the list of links displayed in the left-side pane of FIG. 7C. As illustrated in FIG. 7C, links are provided to pages that permit users to: review general information concerning the financial test (“About the test”); learn how to prepare for the financial test (“Preparing for”); enter financial information in response to questions asked by the system (“Take the test”); view the results of the system's analysis of the financial information (“Results”); view past results prepared by the system for the financial test (“Past results/Data”); and link to educational materials that provide advice concerning the particular skills evaluated by the financial test (“Articles”).

It will be appreciated that in the screen shot of FIG. 7C, the “Take the test” link for the financial test has been selected. It will also be appreciated that the selection of the link can also be performed in step 530 of FIG. 5.

The financial information requested by the financial test can be entered into the various fields illustrated in FIG. 7C, with additional fields being accessible by scrolling up or down the screen. The range of time to which the answers apply (the selected time period) can also be entered into other fields of the screen (not shown).

After the financial information has been entered in response to the questions presented by the system, the user can choose to click on the “Analyze results” link illustrated in FIG. 7C. It will be appreciated that the entry of financial information and the selection of the “Analyze results” link can be performed in step 550 of FIG. 5.

Similar to the office test, a results page can be presented to the user in response to the user's selection of the “Analyze results” link for the financial test. The results page for the financial test provides the results of the analysis performed by the system for different aspects of financial performance. In one embodiment, the following aspects of financial performance are evaluated by the financial test: insurance billing, case acceptance, collection rate, practice income, and patient retention.

Each aspect of financial performance can be grouped into different ratings according to the quality of the financial performance determined by the system. In one embodiment, the following ratings can be used: “Very good,” “Acceptable (Room for improvement),” “Need improvement,” and “Need significant improvement.”

It will be appreciated that by reviewing the results page, the user can conveniently determine which financial aspects of the user's business practice are performing well, and which are not. Each financial aspect of the business practice listed in the results page can be implemented as a link to educational materials pertaining to the selected financial aspect. As a result of this functionality, the user can conveniently access educational materials to address the particular financial deficiencies in the user's business practice pertaining to financial performance.

In one embodiment, the financial information entered by the user can be processed by the system in accordance with the following Table 2:

TABLE 2

| | | Acceptable | | Need |
|---|---|---|---|---|
| | | (Room for | Need | significant |
| Categories | Very good | improvement) | improvement | improvement |
| 1-What is your total | over $60,000/month for | 45,000 to 60,000 | 30,000 to 45,000 | under 30,000 |
| collection (income) | each FT doctor part time | | | |
| | counts as half | | | |
| 2-What is the total | | | | |
| dollar amount of procedures | less than 10% | 10-15% | 15-25% | over 25% |
| that are treatment planned | (of question #1) | | | |
| but not scheduled? | | | | |
| (Case acceptance) | | | | |
| 3-What is the total | 0-3% of | 3-10% | 10-20% | over 20% |
| amount you are owed by | question 1 | | | |
| your patients? | | | | |
| (Collection rate) | | | | |
| 4-What is the amount | less than 20% | 20-60% | 60-100% | over 100% |
| you are owed by insurance | | | | |
| companies? | | | | |
| (Insurance Billing) | | | | |
| 5-What is the total | divide it by 12 and | 100-120% | 80-100% | less than 80% |
| collection for last | then: if it | | | |
| calendar year? | is more than | | | |
| (Patient retention) | 120% of Q1 | | | |

Overhead Test: The overhead test can be accessed by selecting the “Overhead test” link from window pane 502 of FIG. 5. It will be appreciated that the selection of the “Overhead test” link can also be performed in step 530 of FIG. 5.

The overhead test provides a way for a user of the system to receive consulting advice concerning the rate of overhead in the user's business practice, areas of overspending, and/or how to manage expenses based on the processing of overhead information entered by the user in response to questions presented by the system. In various embodiments, the user can provide overhead information based on a selected time period, such as a month, several months, or a calendar year.

In one embodiment, the system can be configured to ask the user to provide the following overhead information:

Payroll expenses

Rent

Dental supplies

Lab fees

Professional services (Legal/Accounting)

Insurance

Marketing

Office supplies

Others (see list)

Total overhead (expenses)

Collection (income)

FIG. 7D provides a sample screen shot of one of the pages that can be provided to a user for the overhead test. Particular pages pertaining to various aspects of the overhead test can be accessed by the user by selecting pages from the list of links displayed in the left-side pane of FIG. 7D. As illustrated in FIG. 7D, links are provided to pages that permit users to: review general information concerning the overhead test (“About the test”); learn how to prepare for the overhead test (“Preparing for”); enter overhead information in response to questions asked by the system (“Take the test”); view the results of the system's analysis of the overhead information (“Results”); view past results prepared by the system for the overhead test (“Past results/Data”); and link to educational materials that provide advice concerning the particular skills evaluated by the overhead test (“Articles”).

It will be appreciated that in the screen shot of FIG. 7D, the “Take the test” link for the overhead test has been selected. It will also be appreciated that the selection of the link can also be performed in step 530 of FIG. 5.

The overhead information requested by the overhead test can be entered into the various fields illustrated in FIG. 7D, with additional fields being accessible by scrolling up or down the screen. The range of time to which the answers apply (the selected time period) can also be entered into other fields of the screen (not shown).

After the overhead information requested by the system has been entered, the user can choose to click on the “Analyze results” link illustrated in FIG. 7D. It will be appreciated that the entry of overhead information and the selection of the “Analyze results” link can be performed in step 550 of FIG. 5.

Similar to the office test and the financial test, a results page can be presented to the user in response to the user's selection of the “Analyze results” link for the overhead test. The results page for the overhead test provides the results of the analysis performed by the system for different aspects of overhead performance. In one embodiment, the following aspects of overhead performance are evaluated by the overhead test: rent, insurance expenses, dental supplies, lab fees, professional services, payroll expenses, marketing, others, total overhead, and office supplies. In addition, the system can be configured to ignore overhead expenses for certain overhead categories such as: hygienist, associate, dental equipment, and/or loan payments.

Each aspect of overhead performance can be grouped into different ratings according to the quality of the overhead performance determined by the system. In one embodiment, the following ratings can be used: “Very good,” “Acceptable (Room for improvement),” “Need improvement,” and “Need significant improvement.”

It will be appreciated that by reviewing the results page, the user can conveniently determine which overhead aspects of the user's business practice are performing well, and which are not. Each overhead aspect of the business practice listed in the results page can be implemented as a link to educational materials pertaining to the selected overhead aspect. As a result of this functionality, the user can conveniently access educational materials to address the particular overhead deficiencies in the user's business practice.

In one embodiment, the overhead information entered by the user can be processed by the system in accordance with the following Table 3, with the percentage being of the same period collection (income) amount:

TABLE 3

| | | Acceptable | Need | Need |
|---|---|---|---|---|
| | | (Room for | improve- | significant |
| Categories | Very good | improvement) | ment | improvement |
| 1-Overhead | under 40% | 40-50% | 50-65% | over 65% |
| review | | | | |
| (total | | | | |
| overhead) | | | | |
| 2-Payroll | under 18% | 18-22% | 22-28% | over 28% |
| expenses | | | | |
| 3-Rent | under 5% | 5-8% | 8-10% | over 10% |
| 4-Dental | under 4% | 4-6% | 6-8% | over 8% |
| supplies | | | | |
| 5-Lab fees | under 5% | 5-8% | 8-10% | over 10% |
| 6-Professional | under 0.5% | 0.5%-1.5% | 1.5-2% | over 2% |
| services | | | | |
| 7-Insurance | under 1% | 1-1.5% | 1.5-2% | over 2% |
| 8-Marketing | under 0.5% | 0.5-1% | 1-2% | over 2% |
| 9-Office | under 1% | 1-2% | 2-3% | over 3% |
| supplies | | | | |
| 10-Others | under 3% | 3-4% | 4-5% | over 5% |

Budgeting Tool: The budgeting tool can be accessed by selecting the “Budgeting tool” link from window pane 502 of FIG. 5. It will be appreciated that the selection of the “Budgeting tool” link can also be performed in step 530 of FIG. 5.

The budgeting tool provides a way for a user of the system to receive consulting advice concerning how to plan their expenses based on the processing of budget information entered by the user in response to questions presented by the system.

In one embodiment, the system can be configured to ask the user to provide budget information in response to the following questions:
Select the month you would like to do budgeting for.
Enter the total collection for the prior month.
The percentage of total overhead planned for next month.
Last month hygiene department income (if a hygienist is used in the business practice).
Percentage of income you feel is fair for your hygienist to take home (if a hygienist is used in the business practice).
Last month associate income (if an associate is used in the business practice).
Percentage of income you feel is fair for your associate to take home (if an associate is used in the business practice).

FIG. 7E provides a sample screen shot of one of the pages that can be provided to a user for the budgeting tool. Particular pages pertaining to various aspects of the budgeting tool can be accessed by the user by selecting pages from the list of links displayed in the left-side pane of FIG. 7E. As illustrated in FIG. 7E, links are provided to pages that permit users to: review general information concerning budgeting (“About budgeting”); enter budget information in response to questions asked by the system (“Budgeting tool”); view the results of the system's analysis of the budget information (“Results”); and view past results prepared by the system for the budgeting tool (“Past results/Data”).

It will be appreciated that in the screen shot of FIG. 7E, the “Budgeting tool” link has been selected. It will also be appreciated that the selection of the link can also be performed in step 530 of FIG. 5.

The budget information requested by the budgeting tool can be entered into the various fields illustrated in FIG. 7E, with additional information being viewable by scrolling up or down the screen.

After the budget information has been entered in response to the questions presented by the system, the user can choose to click on one of the “Budget for the period” links illustrated in FIG. 7E. It will be appreciated that the entry of budget information and the selection of a “Budget for the period” link can be performed in step 550 of FIG. 5.

FIG. 7F provides a sample screen shot of a results page displayed to the user in response to the user's selection of a “Budget for the period” link. As illustrated in FIG. 7F, the system provides a dollar amount allowance for a plurality of budget categories. It will be appreciated that by reviewing the budgeting tool results page, the user can conveniently obtain a realistic budget for the user's business practice, broken down by categories.

In one embodiment, the budget information entered by the user can be processed by the system in accordance with the following Table 4, with the previous month's income multiplied by an earned percentage “A”:

TABLE 4

| Category | Allowance |
|---|---|
| 1-Payroll expenses | 38% (of A) |
| 2-Rent | 15% |
| 3-Dental supplies | 11% |
| 4-Lab fees | 14% |
| 5-Professional services | 3% |
| 6-Insurance | 3% |
| 7-Marketing | 5% |
| 8-Office supplies | 4% |
| 9-Others (merchant fees, | 7% |
| bank fees, laundry and uniforms, | |
| printing and reproduction, | |
| postage, telephone, utility, | |
| outside services, property tax) | |
| 10-Total overhead (does not | A |
| include your salary, auto | |
| expenses or travel costs) | |
| Dental equipment or | Any amount saved on above |
| other investments | expenses, can be invested in dental |
| | equipments or other expenses that |
| | directly improve production, |
| | profitability or patient |
| | satisfaction. |
| Hygienist | Answer 3 multiply by 4 |
| Associates | Answer 5 multiply by 6 |

Referral Test: The referral test can be accessed by selecting the “Referral test” link from window pane 502 of FIG. 5. It will be appreciated that the selection of the “Referral test” link can also be performed in step 530 of FIG. 5.

The referral test provides a way for a user of the system to receive consulting advice concerning the perception of the user's business practice from the perspective of referral sources, such as other healthcare providers.

The user can administer referral surveys to outside referral sources and then enter the results into the system. In one embodiment, the referral surveys utilized by the referral test can be configured to ask outside referral sources to provide ratings of the user's business in response to the following questions:

The courtesy and professionalism of our office staff on the phone.

Return timing of your patients.

Feedback from your patients about our practice in general.

Diagnosis reports are professional and thorough.

Treatment reports are professional and thorough.

Reports are sent in a timely manner.

Your overall satisfaction of your patients treatment provided by us.

Your overall satisfaction with communications between the two offices.

Your general impression of our practice.

Would you recommend us to your colleague as a specialty office to refer to?

FIG. 7G provides a sample screen shot of one of the pages that can be provided to a user for the referral test. Particular pages pertaining to various aspects of the referral test can be accessed by the user by selecting pages from the list of links displayed in the left-side pane of FIG. 7G. As illustrated in FIG. 7G, links are provided to pages that permit users to: review general information concerning the referral test (“About the test”); learn how to prepare for the referral test (“Preparing for”); enter referral survey information into the system (“Taking the test”); view the results of the system's analysis of the referral survey information (“Results”); view past results prepared by the system for the referral test (“Past results/Data”); and link to educational materials that provide advice concerning the particular skills evaluated by the referral test (“Articles”).

It will be appreciated that in the screen shot of FIG. 7G, the “Take the test” link has been selected. It will also be appreciated that the selection of the link can also be performed in step 530 of FIG. 5.

The information obtained from referral surveys returned from outside referral sources can be entered into the various fields illustrated in FIG. 7G, with additional fields being accessible by scrolling up or down the screen. The range of time to which the answers apply can also be entered into other fields of the screen (not shown). Information obtained from additional referral surveys can be entered by selecting an “Enter next result” link provided in the user interface.

After the referral survey information has been entered, the user can choose to click on the “Analyze results” link illustrated in FIG. 7G. It will be appreciated that the entry of referral survey information and the selection of the “Analyze results” link can be performed in step 550 of FIG. 5.

Similar to the office test, financial test, and overhead test, a results page can be presented to the user in response to the user's selection of the “Analyze results” link for the referral test. The results page for the referral test provides the results of the analysis performed by the system for different aspects of referral performance. In one embodiment, the following aspects of referral performance are evaluated by the referral test: phone skills, doctor's skills, patient cycle, diagnostic report, scheduling and follow up, treatment reports, referral rate, practice image, and communication.

Each aspect of referral performance can be grouped in the results page into different ratings according to the quality of the referral performance determined by the system. In one embodiment, the following ratings can be used: “Very good,” “Acceptable (Room for improvement),” “Need improvement,” and “Need significant improvement.” The referral test results page can also display comments received from outside referral sources that were provided with the survey results and entered into the optional comments field of FIG. 7G.

It will be appreciated that by reviewing the referral test results page, the user can conveniently determine which aspects of referral services of the user's business practice are performing well, and which are not. Each aspect of referral performance listed in the results page can be implemented as a link to educational materials pertaining to the selected referral aspect. As a result of this functionality, the user can conveniently access educational materials to address the particular referral deficiencies in the user's business practice.

In one embodiment, the referral information entered by the user can be processed by the system in accordance with the following Table 5:

TABLE 5

| | | Acceptable | | Need |
|---|---|---|---|---|
| | | (Room for | Need | significant |
| Categories | Very good | improvement) | improvement | improvement |
| 1-The courtesy and professionalism | 10 | 9-10 | 8-9 | lower or |
| of our office staff on the phone: | | | | equal to 7 |
| 1-Phone techniques (for | | | | |
| Referral offices) | | | | |
| 2-Return timing of your | 10 | 9-10 | 8-9 | lower or |
| patients: | | | | equal to 7 |
| 2-Scheduling/follow up | | | | |
| 3-Feedback from your patients | 10 | 9-10 | 8-9 | lower or |
| about our practice in general: | | | | equal to 7 |
| 3-Office impression | | | | |
| (same as office test) | | | | |
| 4-Diagnosis reports are | 10 | 9-10 | 8-9 | lower or |
| professional and thorough | | | | equal to 7 |
| 4-Diagnosis re ort desi | | | | |
| 5-Treatment reports are | 10 | 9-10 | 8-9 | lower or |
| professional and thorough | | | | equal to 7 |
| 5-Treatment report design | | | | |
| 6-Reports are sent in a | 10 | 9-10 | 8-9 | lower or |
| timely manner | | | | equal to 7 |
| 6-Patient cycle | | | | |
| 7-Your overall satisfaction | 10 | 9-10 | 8-9 | lower or |
| of your patients treatment | | | | equal to 7 |
| provided by us: | | | | |
| 7-Doctors skills | | | | |
| 8-Your Overall satisfaction | 10 | 9-10 | 8-9 | lower or |
| with communications between | | | | equal to 7 |
| the two offices: | | | | |
| 8-Communication | | | | |
| 9-Your general impression | 10 | 9-10 | 8-9 | lower or |
| of our practice: | | | | equal to 7 |
| 9-Practice image | | | | |
| (referral sources) | | | | |
| Overall score | 100 | 95-100 | 90-95 | under 90 |
| 10-Would you recommend us | Number of “yes” | 90-97% | 80-89% | lower |
| to your colleague as a | divided by total | | | than 80 |
| specialty office to | 98-100% | | | |
| refer to? | | | | |
| 10-Referral rate | | | | |
| (by general practitioner) | | | | |

Enter additional comments for the period in order by numbers

It will be appreciated that by accessing the various educational materials and/or interactive processes provided by various embodiments of a practice management consulting system in accordance with the present invention, a businessperson can receive consulting advice that is relevant to the businessperson's business practice without the need for hiring costly business consultant(s).

It will also be appreciated that various embodiments of the present invention can be implemented using hardware, software, or a combination of both hardware and software. The software used for the present invention can be stored on one or more processor readable storage devices including hard disk drives, CD-ROMs, optical disks, floppy disks, tape drives, RAM, ROM, or other suitable storage devices. In alternative embodiments, some or all of the software can be replaced by dedicated hardware including custom integrated circuits, gate arrays, FPGAs, PLDs, and special purpose computers. Hardware that can be used for the present invention includes computers, handheld devices, telephones (e.g. cellular, Internet enabled, digital, analog, hybrids, and others), and other hardware known in the art. Some of these devices include processors, memory, nonvolatile storage, input devices, and output devices.

It will further be appreciated that the scope of the present invention is not limited by the particular embodiments set forth herein. Other appropriate variations, whether explicitly provided for or implied, are contemplated by the present disclosure. The ordering of various steps described herein can be changed where appropriate to achieve the functionality provided by the present invention. Similarly, individual steps can be combined and/or dissected into fewer or greater numbers of steps where appropriate to provide the functionality described herein.

What is claimed is:

1. A method for electronically providing business consulting services through a user interface displayed by a computing device, the method comprising:
receiving a user's selection of an interactive process;
displaying a page to the user through the user interface in response to the selection;
receiving business information from the user through the user interface, the business information pertaining to a business practice of the user;
receiving an instruction from the user to analyze the business information;
processing the business information in accordance with the interactive process selected by the user; and
displaying results of the processing through the user interface, the results comprising business consulting advice pertaining to the business practice of the user.

2. The method of claim 1, the results comprising ratings of a plurality of aspects of the business practice of the user.

3. The method of claim 2, the method further comprising:
displaying a link for each aspect of the business practice rated in the results, each of the links being associated with educational information pertaining to at least one of the aspects of the business practice rated in the results.

4. The method of claim 1, the method further comprising:
receiving the user's selection of a link; and
displaying educational information associated with the link through the user interface, the educational information comprising practice management information pertaining to the business practice of the user.

5. The method of claim 1, the processing step is performed by application software running on the computing device.

6. The method of claim 1, the processing step is performed by application software running on a server in communication with the computing device.

7. The method of claim 1, the business information comprising information selected from the group consisting of:
office information;
financial information;
overhead information;
budget information; and
referral information.

8. The method of claim 1, the interactive process is selected from the group consisting of:
an office test;
a financial test;
an overhead test;
a budgeting tool; and
a referral test.

9. The method of claim 1, the method further comprising:
providing an online subscription service accessible from the computing device, the subscription service providing practice management information pertaining to the business practice of the user.

10. The method of claim 1, the user interface is displayed by a browser running on the computing device.

11. The method of claim 10, the user interface comprises a plurality of linked web pages.

12. The method of claim 1, the business practice is a dental practice.

13. The method of claim 1, the business practice is a medical practice.

14. The method of claim 1, the business practice is in the field of healthcare.

15. A practice management consulting system for electronically providing business consulting services to a user, the system comprising:
a computing device;
a browser running on the computing device, the browser providing a user interface; and
a computer readable medium with application software stored thereon, the software operable to perform a method when run by the computing device, the method comprising the steps of:
receiving a user's selection of an interactive process,
displaying a page to the user through the user interface in response to the selection,
receiving business information from the user through the user interface, the business information pertaining to a business practice of the user,
receiving an instruction from the user to analyze the business information;
processing the business information in accordance with the interactive process selected by the user, and
displaying results of the processing through the user interface, the results comprising business consulting advice pertaining to the business practice of the user.

16. The system of claim 15, the system further comprising:
a server in communication with the computing device, the software being operable to perform the method when run by the server.

17. One or more processor readable storage devices having processor readable code embodied on the processor readable storage devices, the processor readable code for programming one or more processors to perform a method for electronically providing business consulting services through a user interface displayed by a computing device, the method comprising:
receiving a user's selection of an interactive process;
displaying a page to the user through the user interface in response to the selection;
receiving business information from the user through the user interface, the business information pertaining to a business practice of the user;
receiving an instruction from the user to analyze the business information;
processing the business information in accordance with the interactive process selected by the user; and
displaying results of the processing through the user interface, the results comprising business consulting advice pertaining to the business practice of the user.
